(19) United States
(12) Patent Application Publication
(10) Pub. No.: US 2024/0228253 A1
(43) Pub. Date: Jul. 11, 2024

(54) NOZZLE FOR A STATIC MICRODOSER AND SYSTEM COMPRISING A MICRODOSER WITH SUCH NOZZLE FOR INTRODUCING AN ADDITIVE INTO A CONTAINER

(71) Applicant: SOCIETE DES PRODUITS NESTLE S.A., Vevey (CH)

(72) Inventors: ANDREA COMIN, Nancy (FR); RONY ABOU-NAOUM, Vittel (FR); BRUNO MOUTHON, Martigny-Les-Bains (FR)

(21) Appl. No.: 18/558,965

(22) PCT Filed: May 4, 2022
(86) PCT No.: PCT/EP2022/061893

§ 371 Date: Nov. 3, 2023

(30) Foreign Application Priority Data
May 6, 2021 (EP) 21172408.3

(51) Int. Cl. B67C 3/20; B67C 3/26

(52) U.S. Cl. CPC B67C 3/20; B67C 3/26

(57) ABSTRACT

The invention relates to a nozzle for a microdoser, the nozzle (1) comprising one orifice (4) or a plurality of orifices (4), the nozzle having a total orifice opening area of at least 10 mm². Each orifice (4) is configured so that no circle larger than 1.6 mm in diameter can be inscribed within the opening of said orifice. The nozzle has an opening configuration that allows injection of a large quantity of additive at a low outlet speed, which limits splashing, and that allows the additive to be held by capillarity in the nozzle when the injection stops. The invention also relates to a system for introducing an additive into a container comprising a static microdoser having such nozzle (1) from which at least one jet of an additive issues upon passage of an opening of the container in proximity to the nozzle to introduce the additive into said container.

### FIELD OF THE INVENTION

The present invention concerns the technical field of industrial facilities for filling containers such as bottles or cans with a liquid product, such as filling and bottling or canning lines.

Although the invention is more particularly described in the present document in relation to food product container filling, and is particularly suited for such application, it encompasses the filling of other similar containers typically filled with a liquid or semi liquid product.

The invention relates more particularly to the addition of an additive into a container filled with another liquid material hereafter called “main liquid material”. In the food industry, the additive may typically be an edible flavouring concentrate, and the main liquid material in the can may be any liquid beverage product base such as water, soda, lemonade, a functional beverage, a soup, and so on.

The term “additive” relates in the present document to a liquid component, or to a liquid component comprising small solid particles.

The present invention even more particularly relates to static-microdosers, which is one of the two known technologies for introducing a small quantity of an additive into a container, as hereafter detailed. While the term “microdoser” generally designates a device for dosing a fluid in the microliter range, it should be noted that it is used in the present document to designate a device, which is able to dose a fluid up to one or a few milliliters. Such quantity, e.g. up to five milliliters, is a typical quantity of additive such as an aroma added into a beverage base (such as water, or a soda base) to form the desired beverage (such as flavoured drinkable water or soda having the desired taste).

### BACKGROUND OF THE INVENTION

The preparation of a liquid product, for example in the food industry, may require incorporating a small quantity of an additive into a container, empty or partly filled with a main liquid material. This consists in injecting into the main liquid material a small amount of a concentrated formulation (i.e. the additive) such as an aroma, which is a liquid having a highly concentrated flavor.

The main liquid material can be for example water, sparkling water, or a soda base. Such preparation can be used to create flavoured water, flavoured sparkling water, or a soda.

A known solution to introduce a small quantity of liquid into a container is the use of a device called “static microdoser”. A static microdoser consists of a fixed device configured to generate a jet of additive when a container aperture passes under a nozzle of the microdoser.

While static microdosers are simple and easy to use devices, they have drawbacks. The quantity of liquid that may be introduced with such a device is very limited, due to the limited time available for injection The time available for injection is defined by the time of passage of the opening (mouth, open neck) of a container under the injection nozzle.

The use of a static microdoser is thus not envisioned in the state of the art to introduce an additive into a can (e.g. a beverage can) partially filled with a main liquid material, in particular at a speed above 20 000 cans per hour, as microdosing solutions are normally used in low speed applications. Indeed, due to the relatively large quantity (such as a few milliliters) of additive that must be injected into the can and the small time available for injection, the injection flowrate of the injected additive must be high. When additive is injected into a container at a high flow rate, the risk of splashing in reaction to the incoming jet of additive is high. This may result in a loss of liquid from the container, i.e. a loss of main liquid material present in the bottle or can before injection of additive, and/or a loss of additive injected into the bottle or can.

First, such loss makes the quantity of additive in the final product (composed of the main liquid material and additive(s)) variable. Moreover, the additive is generally a very concentrated product. For example, in the case of flavoured waters or soda, the typical ratio of additive to main liquid material in the final product is comprised between 1 to 5 volumes of flavourings (additive) to 1000 volumes of water (or other main liquid material). A small variation in quantity of additive can thus strongly affect the quality of the final product, for example its taste. Any product splash can be a source of uncertainty in the dosing ratio (additive weight to main liquid material weight), and can increase the net weight variability beyond acceptable limits.

Second, splashing on an outside surface of the container or splashing on the canning line is not acceptable for a food product. It can promote microbiological development. Splashing of additive may be acceptable only if the fluid evaporates without leaving any trace on the bottle, as liquid nitrogen does. That is why static microdosers are commonly used only for introduction of liquid nitrogen into a container.

Therefore, while static microdosers are usually not suitable for such applications, the Applicant has developed solutions making it possible to use a static microdoser to introduce an additive such as an aroma into a container prefilled with a main liquid material such as a bottle or a can of a food product such as a beverage.

The solutions developed by the Applicant make it possible in particular to avoid splashing that can be caused by such static microdoser due the relatively large quantity of additive that must be introduced in a short time available for injecting the additive.

Nevertheless, one drawback of a static microdoser can remain, in that when the injection of additive is stopped, a small quantity of liquid remains in the nozzle of the static microdoser. This small quantity of liquid can fall from the nozzle at some point that is not known and not predictable.

The drops that can fall in this way are problematic. First, they can soil the production line, that is to say the bottling line or the canning line. This is not acceptable on a food production line.

Second, an unpredictable fall of liquid from the nozzle increases the uncertainty of the volume actually dosed in the container.

The invention aims to provide solutions to avoid such additive drop or to limit its consequences on the final product, in particular in a device for introducing an additive into a container (such as a bottle or can) using a static microdoser.

### SUMMARY OF THE INVENTION

The objective set out above is met with a nozzle for a microdoser, comprising one orifice or a plurality of orifices. The nozzle has a total orifice opening area of at least 10 mm². Each orifice is configured so that no circle larger than 1.6 mm (preferably 1.5 mm, preferably 0.5 mm or 0.3 mm) in diameter can be inscribed within the opening of said orifice.

The nozzle provided in the invention thus combines two important features. First of all, the opening area of the nozzle is sufficient to allow injection of a relatively large quantity of additive at a sufficiently low outlet speed. In addition, the configuration of the orifice or orifices forming the opening of the nozzle allows the additive that has not come out from the nozzle, when the injection of additive stops, to be held in the nozzle by a combination of adhesion and surface tension of the fluid, later indicated as capillarity.

When the nozzle comprises multiple holes, it is advantageously configured such that the jets issuing from said holes do not combine before they reach the main liquid material present in the container in which additive is introduced. This provides distributed impacts over the surface of the main liquid material and limits splashing. The jets can thus be parallel or diverging. They hit the surface of the main liquid material in parallel paths (because the container moves at a certain speed under the microdoser provided with the nozzle).

The nozzle can comprise a flat base surface, and each orifice can be formed on a stud protruding from said base surface. Each stud can be cylindrical and can have a diameter of 5 mm or less, and preferably of 3 mm or less. Each stud can have a length of at least 2 mm, and preferably at least 10 mm.

Providing each orifice on a stud provides a better control of the shape of the drops that can accidentally fall from the nozzle. Indeed, the size of a drop is largely determined by the size and the geometry of the surface on which it is formed. The orifices of the nozzle being provided on limited outlet surfaces, the drops that may form around theses orifices will also be limited and constant in size. Furthermore, these drops also remain near the orifice from which it has issued. The drop cannot form and stay away from the orifice. Thus, such drop will be carried away by the following jet and transferred into a container. The risk of a drop accidentally falling from the nozzle and soiling the filling line, is limited.

The nozzle can comprise a plurality of circular orifices.

The circular orifices provided in such embodiment can have the same diameter. Each circular orifice has a diameter of 1.6 mm or less, to provide the capillarity feature sought in the invention.

When the nozzle comprises more than one orifice, the orifices can be aligned along a single line or arranged in a matrix configuration. For example, the nozzle can comprise three to ten orifices.

The distribution of the orifices over the surface of the nozzle makes it possible to distribute the impacts of the jets, which issue from the nozzle over the free surface of the main liquid material into which the additive is introduced.

Each orifice can have an opening formed of at least one elongate curvilinear opening. Each elongate curvilinear opening of the orifice can have a width, comprised between 0.2 mm and 0.6 mm, such as a constant width of 0.3 mm or 0.5 mm.

By providing curvilinear opening of small width, the two important features of a nozzle according to the present invention, namely a relatively large opening area and retention by capillarity of the additive are obtained. In particular, the retention by capillarity feature is obtained because all along the path of the opening (defined by a curved line or curved lines), two opposite walls are present, that are less than 1.5 mm apart.

Each elongate curvilinear opening of the orifice has preferably a constant width: all along the path of the opening (defined by a curved line or curved lines), the minimum distance of the two opposites walls remains constant. In this way, in all points of the opening, the surface tension can equally prevent the detachment of the additive due to gravity, hence the dripping of the nozzle.

The provided opening having the form of a curved line can advantageously be manufactured making use of electro-erosion techniques.

For example, each elongate orifice opening can be spiral shaped. In a particular embodiment, the spiral of the opening can be formed by a succession of circle arcs, each circle arc extending over an angle of more than 270°, and smooth junction portions between said circle arcs.

A spiral-shaped opening is particularly suited to the present invention in that it allows an opening of great length and very small width to be obtained while providing a large opening surface area relative to the total surface of the spiral.

Using a spiral based on a succession of arcs of a circle (preferably almost full circles) provides an opening whose outer contour is circular (which will allow a jet of regular shape to be obtained). The manufacturing of such spiral opening is also simplified compared to a spiral having a continuously variable radius

Many alternative opening shapes can be used, depending on the application, for example to obtain the desired shape of additive jet, and/or the desired distribution of the impact zones of the jet over the free surface of the main liquid material into which the additive is introduced. Each orifice opening can be formed of several spiral openings. Each curvilinear opening can be serpentine shaped or has a shape based on chicanes.

The nozzle, provided with one or several curvilinear opening(s), can comprise, for example, one to ten orifices.

As with circular orifices, using more orifices increases the total (cumulative) opening area of the nozzle, and the distribution of the orifices over the surface of the nozzle makes it possible to distribute the impacts of the jets, which issue from the nozzle over the free surface of the main liquid material into which the additive is introduced. For a given quantity of additive introduced in a given time, increasing the opening area of the nozzle also decreases the jet speed.

The nozzle can comprise, for each orifice, a straight internal channel having a uniform cross-section having the shape of said orifice, the internal channel having a length of at least 30 times:
the diameter of the orifice if the orifice is circular, or
the width of the orifice opening if the orifice has a curvilinear opening.

Such a length of internal channel inside the nozzle makes it possible to ensure a regular flow of the additive in each channel. It also ensures the effectiveness of the capillarity feature in retaining the additive drops.

The converging portion reduces the surface present around the orifices. If a drop forms by accumulations of small quantities of additive accidentally issued form the nozzle or remaining on the nozzle after an injection of additive this drop will remain next to the injection orifices and will be drawn into the container by the subsequent jet.

The inlet of each channel, that is opposite to the nozzle opening, can be covered by a grid having openings of 150 micrometres or less. This corresponds to a US standard mesh of 100 or more. The grid can be formed, for example, of a perforated plate or of a meshed wire strainer. The grid uniforms the flow of additive through the channels and orifices of the nozzle.

The invention also relates to a system for introducing an additive into a container comprising a static microdoser having a nozzle as above described from which at least one jet of an additive issues upon passage of an opening of the container in proximity to the nozzle to introduce the additive into said container.

The nozzle of the microdoser can be inclined relative to a vertical direction

A nozzle according to the present invention can thus be used on a line for filling containers with a liquid food product. The nozzle can in particular be used in the manufacture of a beverage, for the introduction of an additive such as an aroma. This nozzle is particularly suitable for use in an embodiment of a filling line in which the nozzle has an inclination making it possible to limit splashing.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic three-dimensional view of a nozzle according to an embodiment of the invention;

FIGS. 2A-2G are schematic views showing several orifice repartitions that can be used in nozzles according to several embodiments of the invention;

FIG. 3 is a schematic view of a nozzle according to an embodiment of the invention;

FIG. 4A and FIG. 4B are a schematic views of nozzles according to embodiments of the invention;

FIG. 5 is a schematic three-dimensional view of a nozzle according to an embodiment of the invention;

FIG. 6A, FIG. 6B and FIG. 6C are schematic three-dimensional views of nozzles according to embodiments of the invention.

FIG. 7 is a schematic three-dimensional view of a nozzle according to an embodiment of the invention;

FIG. 8 is a schematic side-view of the nozzle of FIG. 7;

FIG. 9 is a schematic three-dimensional view of a nozzle according to an embodiment of the invention.

FIG. 10 is a schematic side-view of the nozzle of FIG. 9.

### DETAILED DESCRIPTION

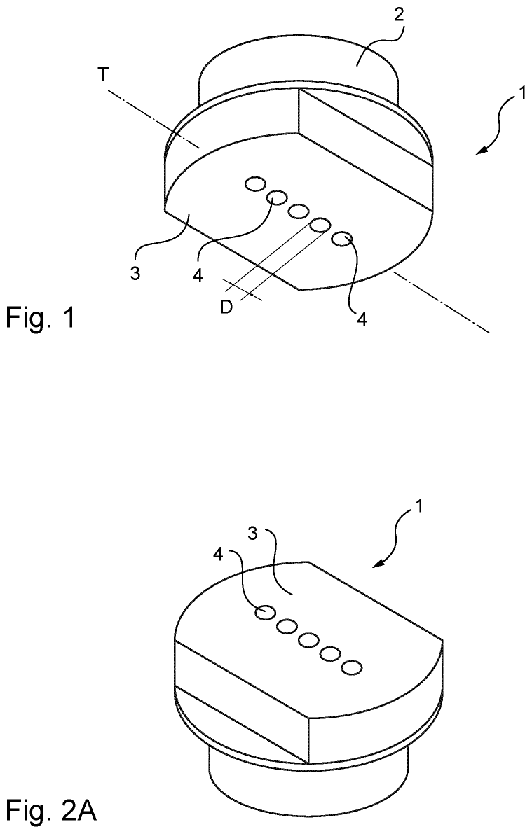

FIG. 1 is a schematic three-dimensional view of a nozzle according to a first example embodiment of the invention.

The nozzle 1 is configured to be fixed to a static microdoser. The nozzle 1 is provided, in the represented example, with a threaded part 2 adapted to be screwed into a corresponding fixation tapping of the microdoser.

The nozzle has a base surface 3. The opening of the nozzle issues on said base surface 3. In the represented embodiment, the opening is formed by several orifices 4, namely five orifices 4. The five orifices 5 are aligned. More particularly, the orifices 4 are aligned on a line T that is intended to be transverse (perpendicular) to the trajectory of the containers that travel under the nozzle on a filling line.

When the nozzle is used to introduce an additive into a standard can, having a cylindrical shape and a diameter around 50 mm, the orifices can advantageously be distributed (along a line or according to a matrix arrangement as explained hereafter) over a width of 15 mm or more, and preferably 30 mm or more.

In this example, each orifice is circular. To provide the nozzle with an opening having a total (cumulative) area over the base surface 3 of 10 mm² or more, each orifice has a diameter D around 1.6 mm.

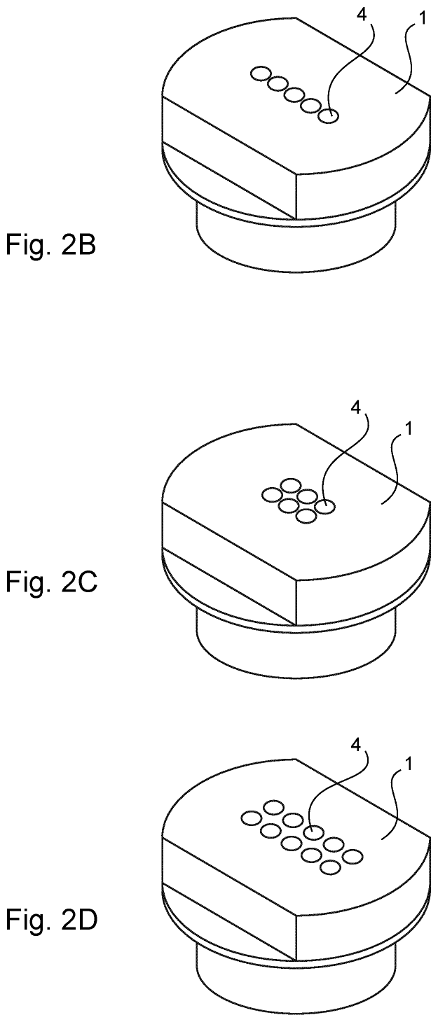

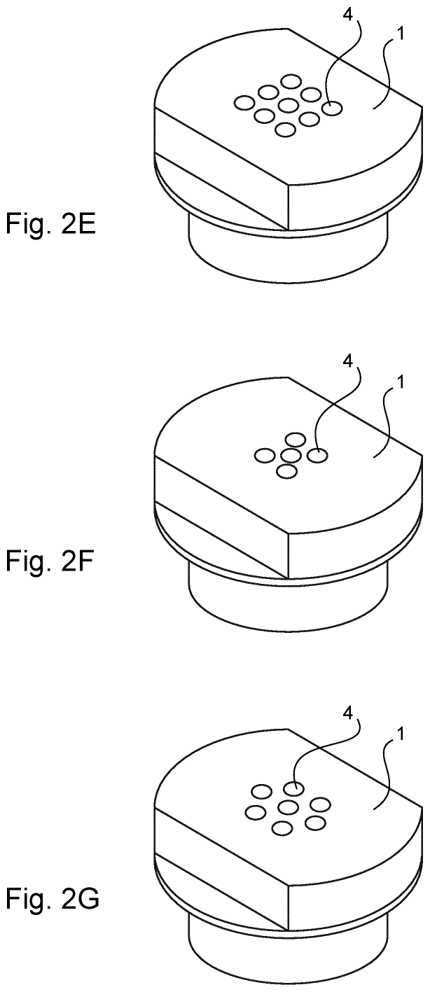

FIGS. 2A-2G are schematic views showing several orifice arrangements in several nozzle embodiments of the invention.

FIG. 2A shows a nozzle having a row of five circular orifices 4, corresponding to the nozzle 1 of FIG. 1.

FIG. 2B shows a nozzle 1 having five aligned circular orifices 4. The orifices 4 of this embodiment are arranged in a much closer proximity to each other than in the embodiment of FIG. 2A. This shows that, in all the embodiments, the spacing between the orifices 4 can be adapted according to the desired distribution of said orifices. A minimum distance ensures that the jets do not combine, which would lead to an uncertain jet shape.

FIG. 2C shows a nozzle 1 having orifices 4 disposed in a matrix arrangement. In a matrix arrangement, parallel rows of orifices 4 are formed on the nozzle. In the embodiment of FIG. 2C, the nozzle 1 is provided with two parallel rows of three orifices 4.

FIG. 2D shows a nozzle 1 having ten orifices 4 arranged in a matrix arrangement comprising two parallel rows of five orifices.

FIG. 2E shows a nozzle 1 having nine orifices 4 disposed in a matrix arrangement comprising three parallel rows of three orifices 4.

FIG. 2F shows a nozzle 1 having five orifices 4 distributed in a regular arrangement comprising a central orifice. This arrangement can also be considered as a matrix arrangement comprising two external rows of two holes and a central line of one hole, in which each row is offset with respect to the preceding row and to the following row by half the distance between two orifices of the same row. FIG. 2G shows nozzle 1 having seven orifices 4 arranged in such matrix arrangement.

According to the present invention, to obtain adapted properties of retention of liquid by capillarity, no circle larger than 1.6 mm (and preferably 1.5 mm) in diameter can be inscribed within the opening of the nozzle. If the nozzle 1 has circular orifices such as shown in FIGS. 2A-2G, this means that all the circular orifices have a diameter of 1.6 mm or less. If the nozzle 1 has elliptical orifices, this means that the minor axis of the ellipse is 0.75 mm or less.

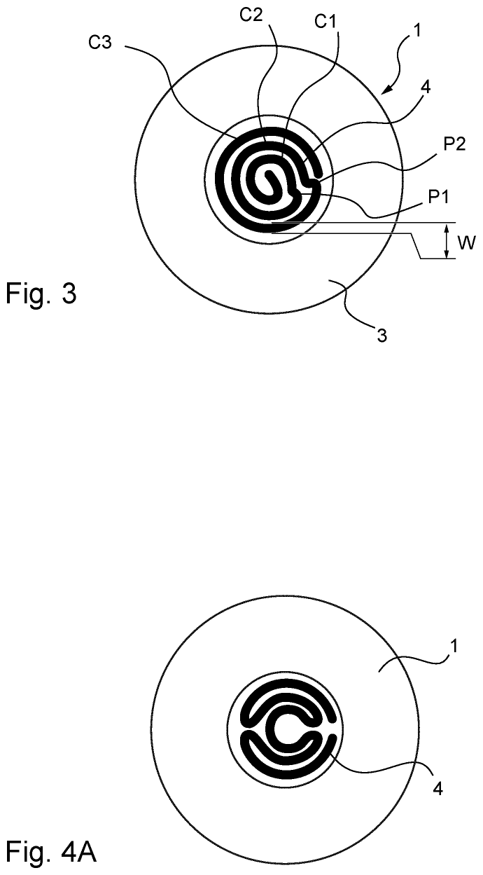

FIG. 3 shows another embodiment of a nozzle according to the present invention. In the embodiment of FIG. 3, to obtain the feature that no circle larger than 1.5 mm in diameter can be inscribed within the opening of the orifice 4, the opening of the orifice 4 is curvilinear (i.e. the orifice 4 has a shape containing or consisting of curved lines). The opening of the orifice 4 has a substantially constant width W. The width W of the orifice opening is of 1.6 mm or less. To enhance the capillarity and dripping retention properties of the nozzle, a width comprised between 0.2 and 0.6 mm is preferred.

In the embodiment of FIG. 3, the elongate curvilinear orifice 4 is spiral shaped. While an orifice formed along a spiral line having a constantly varying radius of curvature can be used in an embodiment of the invention, the spiral of FIG. 3 is formed of concentric circle arcs C1, C2, C3 and smooth junction portions P1, P2. Such spiral shaped orifice that is inscribed in a circle provides an orifice having a great length over a small area. It also provide a jet of regular shape.

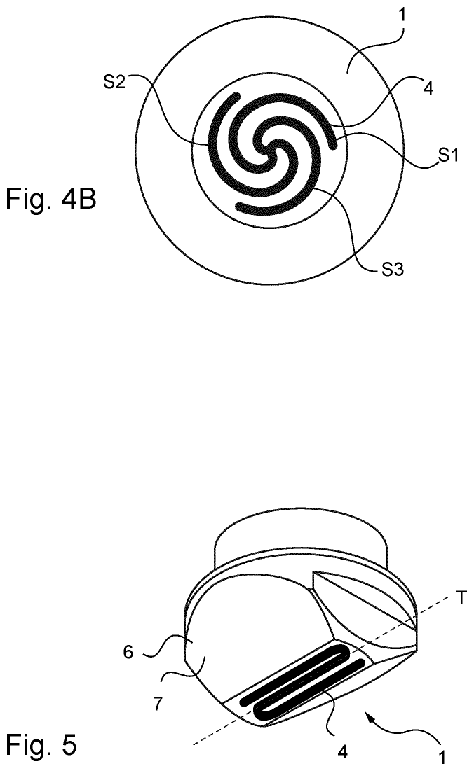

Many alternative embodiments of the invention can be based on this principle of forming a curvilinear orifice. FIG. 4A shows an alternative embodiment using this principle. The orifice embodiment of FIG. 4A is formed of a succession of arcs arranged to form an orifice having a complex shape based on chicanes, forming a “zigzag” shape.

FIG. 4B shows another alternative embodiment of a nozzle according to the invention. In the embodiment of FIG. 4B, the orifice of the nozzle has an opening that is formed by several spiral openings. More particularly, the opening of the nozzle of FIG. 4B is formed of three spiral openings S1, S2, S3. The three spiral openings have a common central starting point. This starting point constitutes in this embodiment the area of greatest width of the opening. For example, this central point can form a circular opening whose diameter is less than 1.6 mm. The three spirals S1, S2, S3 are identical and angularly offset, so as to form a regular opening pattern. Such opening configuration provides a large opening area over a reduced surface, and is stiffer than openings based on conventional spirals.

FIG. 5 shows an embodiment of the nozzle 1, in which the orifice 4 is curvilinear and has a serpentine shape, and more particularly an “S” shape. In the embodiment shown in FIG. 5, the orifice 4 extends over a substantial length in the direction of the line T that is intended to be transversal (perpendicular) to the trajectory of the containers that travel under the nozzle on a filling line.

The orifices of the embodiments of the nozzle in which the orifices are curvilinear can be manufactured using electro-erosion techniques. These techniques enable small orifices of complex shapes to be formed in a metal nozzle tip.

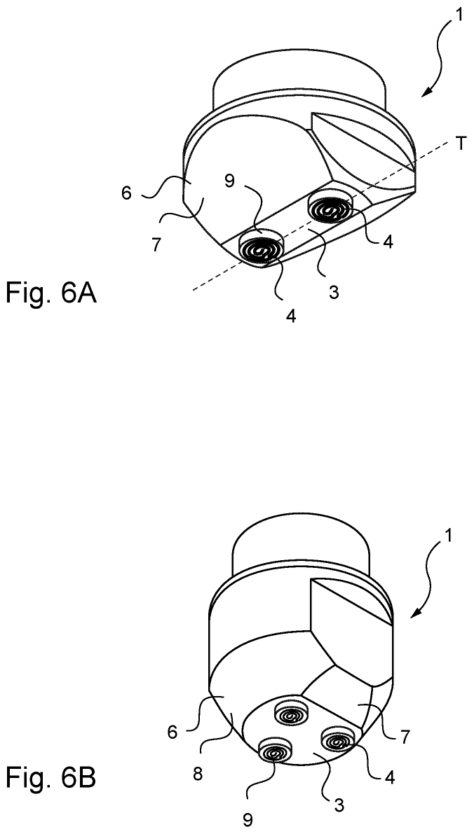

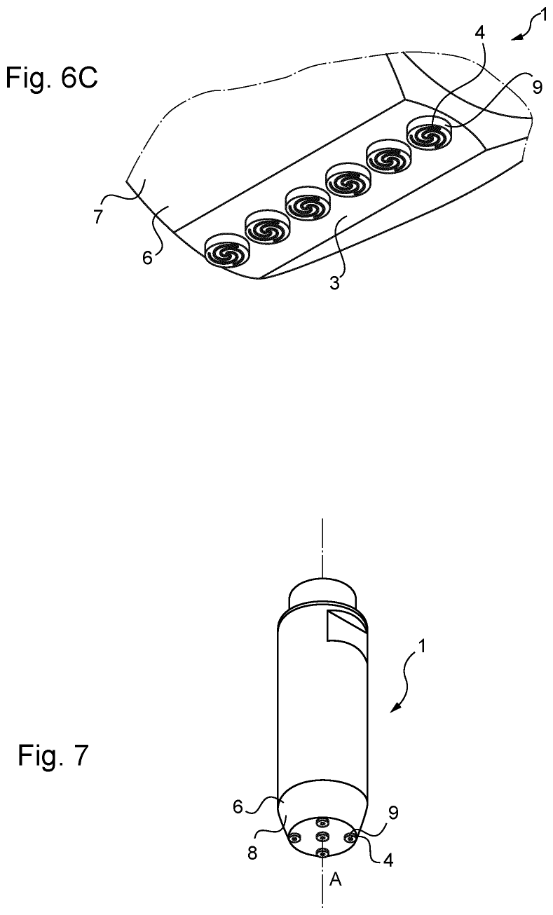

FIG. 6A, FIG. 6B and FIG. 6C illustrate that several curvilinear orifices can be formed in the nozzle. The arrangement or distribution of these orifices can be for example as described in FIGS. 2A-2G, namely aligned, in a matrix arrangement, or with any other regular distribution.

In FIG. 6A, the nozzle 1 comprises two spaced apart spiral shaped orifices 4. The two orifices are preferably situated on the line T that is intended to be transversal to the trajectory of the containers that travel under the nozzle on a filling line.

In FIG. 6B, the nozzle comprises three spiral-shaped orifices, distributed at the three corners of an equilateral triangle.

In FIG. 6C, the nozzle comprises six aligned orifices. Each orifice has an orifice opening formed of several spirals (like the nozzle opening shown in FIG. 4B). The nozzle of FIG. 6C thus provides a large total opening area, a distribution of the orifices over a large width of the nozzle, while each spiral orifice has a small width (e.g. 0.3 mm).

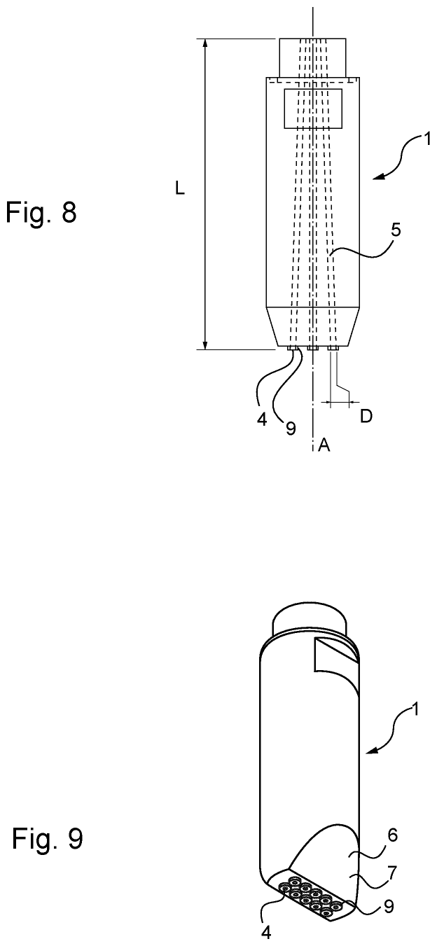

FIG. 7 and FIG. 8 illustrate another aspect of the present invention. FIG. 7 shows a nozzle according to an embodiment of the invention. In the represented embodiment, the nozzle comprises five circular orifices 4, namely a central orifice and four orifices distributed at the periphery of the nozzle tip. As shown in FIG. 7, the nozzle has a long length along its main axis A.

FIG. 8 is a schematic side-view of the nozzle of FIG. 7. The internal channels of the nozzle that issue onto a surface of the nozzle to form the orifices, are represented by dotted lines in FIG. 8. Each channel of the nozzle is a straight channel. The length L of each channel is at least 30 times (preferably 50 times) the width W of the orifice opening or its diameter D. In the represented embodiment in which each orifice is circular, each internal channel 5 has a length L of at least 30 times the diameter D.

A sufficient length of the channel ensures that the additive flows in the nozzle channels with a regular velocity distribution, and forms a steady jet at the exit of the nozzle. Furthermore, in general, the longer the channel, the stronger the retention effect by capillarity. A channel having a length of 30 times the relevant dimension of the orifice also ensures with a good level of certainty that the capillary effect will be sufficient to maintain inside the nozzle the additive present in the channels when the additive injection stops.

As can be seen in FIG. 8, the channels 5 are straight but not necessarily perfectly parallel to the main axis A of the nozzle. The inclination of the channels towards the center of the nozzle shown in FIG. 8 allows a simpler and more uniform supply of additive to each of the channels 5, and therefore to each of the orifices 4.

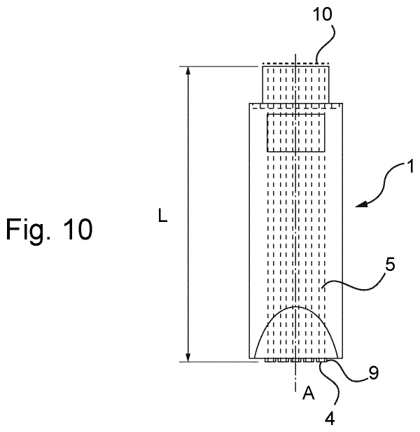

FIGS. 9 and 10 show another example embodiment that illustrate the aspect developed with reference to FIGS. 7 and 8.

In the example embodiment of FIG. 9, the nozzle comprises ten circular orifices 4 distributed in a matrix arrangement comprising two rows of five orifices 4.

As shown in FIG. 10, the nozzle thus comprises ten straight internal channels 5. The length L of each channel is at least 30 times the diameter D of the orifices (and preferably 50 times the diameter D of the orifices as shown in the represented example embodiment). In this embodiment, each channel extends parallel to the main axis A of the nozzle.

The nozzle of FIG. 10 is provided with a grid 10 at the inlet of each channel 5. More particularly, each channel inlet is at the end of the channel opposite to the end of the channel forming a nozzle outlet opening and is covered by a grid 10 having openings of 150 micrometres or less (which corresponds to a US standard mesh of 100 or more). The grid 10 uniforms the flow of additive through the channels 5 and orifices of the nozzle.

The grid 10 can be formed, for example, of a perforated plate or of a meshed wire strainer.

A grid as shown in FIG. 10 can be provided in all the embodiments of the present invention.

In some embodiments of the invention, the nozzle further comprises features to avoid drop stagnation and/or large drop formation on the nozzle tip.

First, as shown in FIGS. 5, 6A, 6B, 6C, 7 and 9, the nozzle can be provided with a portion converging toward the injection orifices 4. This converging portion 6 can comprise one or several flat slopes 7 and/or one or several frusto-conical portions 8.

The converging portion reduces the size of the base surface 3 of the nozzle around the orifices 4. This avoids any drop stagnation away from the nozzle flow. The inclination of the converging portion 6 (i.e. its dimension in the direction of the main axis A of the nozzle) can take into account the adhesion properties of the additive.

Furthermore, in alternative or in complement to the converging portion 6 of the nozzle, each orifice 4 can be formed on a stud 9 that forms an edge around the orifice 4.

Providing each orifice 4 on a stud provides a better control of the shape and size of the drops that can accidentally form and fall from the nozzle. Indeed, the size of a drop is determined by the size of the stud. A stud of small dimensions (e.g. a small diameter) is thus preferred. The stud has preferably a length (in a direction parallel to the main axis A of the nozzle) of at least 2 mm, preferably at least 10 mm.

The present invention thus provides microdoser nozzles making it possible to introduce a relatively large quantity of an additive (such as 0.1 ml to 10 mL) into a container, at a reasonable speed that limits the risk of splashing, while ensuring that the additive present in the nozzle when the injection stops is reliably maintained in the nozzle by capillarity.

The present invention also provides nozzle configurations that make it possible to increase the surface area of the main liquid material present in the container into which additive is injection that is hit by the jet or jets of additive issuing from the nozzle. This limits the energy per unit area of the free surface of the main liquid material transferred by the jets of additives, or makes it possible to inject more additive in a given time without splashing.

The nozzle according to the invention can for example be used to introduce 0.1 to 10 mL (such as 0.2 to 0.7 mL) of an additive having a fluid dynamic viscosity comprised between 0.5 and 1000 mPa·s (such as from 0.8 to 100 mPa·s, and preferably 0.9 to 50 mPa·s) in 10 to 100 ms. This makes it possible to add additive in 20.000 to 100.000 standard cans (having a 50 mm or a 52 mm diameter) per hour using one single nozzle.

It should be understood that various changes and modifications to the presently preferred embodiments described herein will be apparent to those skilled in the art. Such changes and modifications can be made without departing from the spirit and scope of the present invention and without losing its attendant advantages. It is therefore intended that such changes and modifications be covered by the appended claims. Furthermore, the features described above can generally be used alone or in combination in embodiments of the invention.

The invention finds a preferred, but of course not exclusive, application in the introduction of a flavouring concentrate in cans for beverages preparation, such as flavoured water and soda preparation.

1. Nozzle for a microdoser, the nozzle comprising at least one orifice, the nozzle having a total orifice opening area of at least 10 mm²,
the orifice is configured so that no circle larger than 1.6 mm in diameter can be inscribed within the opening of said orifice.

2. Nozzle according claim 1, wherein it comprises a flat base surface, and each orifice is formed on a stud protruding from said base surface.

3. Nozzle according to claim 2, wherein each stud is cylindrical and has a diameter of 5 mm or less.

4. Nozzle according to claim 2, wherein each stud has a length of at least 2 mm.

5. Nozzle according to claim 1, wherein it comprises a plurality of circular orifices.

6. Nozzle according to claim 1, wherein the orifices are aligned along a single line or arranged in a matrix configuration.

7. Nozzle according to claim 5, wherein it comprises at least three orifices.

8. Nozzle according to claim 1, wherein each orifice has an opening formed of at least one elongate curvilinear opening.

9. Nozzle according to claim 8, wherein each elongate curvilinear opening of the orifice has a width of between 0.2 mm and 0.6 mm.

10. Nozzle according to claim 8, wherein each elongate orifice opening is spiral shaped.

11. Nozzle according to claim 10, wherein the spiral is formed by a succession of circle arcs, each circle arc extending over an angle of more than 270°, and smooth junction portions between said circle arcs.

12. Nozzle according to claim 8, wherein each orifice opening is formed of several spiral openings.

13. Nozzle according to claim 8, wherein each curvilinear opening is serpentine shaped or has a shape based on chicanes.

14. Nozzle according to claim 8, wherein it comprises one to ten orifices.

15. Nozzle according to claim 1, wherein the nozzle comprises, for each orifice, a straight internal channel having a uniform cross-section having the shape of said orifice, the internal channel having a length of at least 30 times:
the diameter of the orifice if the orifice is circular, or
the width of the orifice opening if the orifice has a curvilinear opening.

16. Nozzle according to claim 15, wherein the inlet of each channel, that is opposite to the nozzle opening, is covered by a grid having openings of 150 micrometres or less.

17. Nozzle according to claim 1, wherein it comprises a converging portion that converges toward the orifices of the nozzle.

18. A system for introducing an additive into a container comprising a static microdoser having a nozzle comprising at least one orifice, the nozzle having a total orifice opening area of at least 10 mm²,
the orifice is configured so that no circle larger than 1.6 mm in diameter can be inscribed within the opening of said orifice, from which at least one jet of an additive issues upon passage of an opening of the container in proximity to the nozzle to introduce the additive into said container.

19. A system according to claim 18, wherein the nozzle of the microdoser is inclined relative to a vertical direction.
